(19) United States
(12) Patent Application Publication
(10) Pub. No.: US 2026/0063755 A1
(43) Pub. Date: Mar. 5, 2026

(54) METHOD FOR REDUCING DOPPLER AMBIGUITIES WHEN EVALUATING A PLURALITY OF MODULATION CYCLES

(71) Applicant: Robert Bosch GmbH, Stuttgart (DE)

(72) Inventors: Benedikt Loesch, Stuttgart (DE); Tobias Schmid, Fluorn-Winzeln (DE)

(21) Appl. No.: 19/282,031

(22) Filed: Jul. 28, 2025

(30) Foreign Application Priority Data
Aug. 28, 2024 (DE) 10 2024 208 153.1

(51) Int. Cl. G01S 7/295; G01S 7/282; G01S 13/10; G01S 13/58; G01S 13/87

(52) U.S. Cl. CPC G01S 7/295; G01S 7/282; G01S 13/10; G01S 13/581; G01S 13/87

(57) ABSTRACT

A method for operating a radar sensor or radar network. The method includes: transmitting at least of at least three frames of frequency-modulated radar signals, in each case with a defined duration of a frame and a plurality of frequency-modulated radar signals per frame, wherein transmitting includes a defined pause between in each case two frames, wherein the duration of the frames and/or the duration of the pauses are selected in such a way that the midpoints of the frames exhibit a non-equidistant arrangement relative to one another; receiving and processing reflected signals; and jointly evaluating a plurality of frames.

### CROSS REFERENCE

The present application claims the benefit under 35 U.S.C. § 119 of Germany Patent Application No. DE 10 2024 208 153.1 filed on Aug. 28, 2024, which is expressly incorporated herein by reference in its entirety.

### FIELD

The present invention relates to a method for operating a radar sensor or radar network for reducing ambiguities in a joint evaluation of a plurality of frames of radar signals. The present invention further relates to a radar sensor and to a radar network for carrying out such a method.

### BACKGROUND INFORMATION

Radar systems for measuring distance, relative velocity and angle of targets are increasingly used in motor vehicles for safety and comfort functions as components of driver assistance systems. The accuracy of radar measurements and their resolution of relative velocities are playing an increasingly important role, as driver assistance systems and autonomous driving functions require the most accurate possible detection of the environment.

For radar sensors as components of driver assistance systems in motor vehicles, modulation methods are often used that frequency modulate the signals in a chirp method. Another modulation method used is orthogonal frequency modulation (OFDM, Orthogonal Frequency Division Multiplexing), in which the frequency band is divided into a plurality of orthogonal subchannels. In both, a radar signal can be transmitted with a sequence of signals for sampling (frames) followed by a pause without signals. In a chirp sequence method, a frame is formed by a sequence of a plurality of chirp signals; in an OFDM method by transmitting a plurality of OFDM symbols.

For radar measurements, the resolution of the relative velocity Δv of the radar system depends on the measurement duration Tf, where

$$Δ v = \frac{c}{2 {f}_{0} * {T}_{f}} .$$

Here, c denotes the velocity of light and f₀ the center frequency of the corresponding radar modulation. A high resolution is advantageous because it allows as many targets as possible to be detected and small differences or changes in relative velocity can be separated. The maximum measurement duration Tf is limited; depending on the application, it is restricted by requirements such as maximum permissible latency until the result is output and maximum clearly measurable relative velocity, but can also be limited by other aspects such as thermal conditions. The maximum measurement duration Tf also limits the maximum duration of the frames. Therefore, a joint evaluation of a plurality of frames or entire measurement cycles can significantly increase the effective measurement duration. As a result, the resolution of the relative velocity compared to the evaluation of a single measurement cycle is also significantly improved. However, due to the pauses between the frames, ambiguities arise in the determination of the relative velocity. These are caused by undersampling in the Doppler domain. Without a clear determination of velocity, incorrect assessments of the vehicle's environment may occur, as a result of which the effectiveness of the safety functions of a driver assistance system is impaired. This is particularly true in the context of collision avoidance, adaptive cruise control and lane keeping assistance systems.

### SUMMARY

An object of the present invention is to provide a method for operating a radar sensor or radar network that makes a high resolution and a clear determination of velocity possible. Advantageous embodiments and further developments of the present invention emerge from the disclosure herein.

A method according to an example embodiment of the present invention for operating a radar sensor or radar network comprises the following steps:

Transmitting at least three frames of frequency-modulated radar signals, in each case with a defined duration of a frame and a plurality of frequency-modulated radar signals per frame, wherein transmitting comprises a defined pause between in each case two frames, wherein the duration of the frames and/or the duration of the pauses are selected in such a way that the midpoints of the frames exhibit a non-equidistant arrangement relative to one another; receiving and processing reflected signals; and jointly evaluating a plurality of frames.

The duration of the frames and/or the duration of the pauses are selected in such a way that the time offsets between the center points of in each case two consecutive frames are different relative to one another. For example, the duration of the frames and/or the duration of the pauses are selected in such a way that the time offset between the midpoints of a first and a second frame is different from the time offset between the midpoints of the first frame and a third frame or from the time offset between the midpoints of the second frame and a third frame. In particular, the duration of the frames and/or the duration of the pauses are selected in such a way that evaluating a plurality of frames in the cross-frame relative velocity spectrum does not exhibit any velocity hypotheses with an identical power level.

By means of the method according to the present invention, ambiguities occurring in the determination of the relative velocity can be suppressed in such a way that a clear determination of the velocity of a target is possible, wherein, in the evaluation of a plurality of frames in the cross-frame relative velocity spectrum, there are no velocity hypotheses with an identical high power level. Therefore, the method according to the present invention makes possible a high resolution with a long measurement duration across a plurality of frames and at the same time ensures a clear determination of velocity. A plurality of frames are, for example, two to eight frames.

According to a preferred example embodiment of the present invention, the frequency-modulated radar signals are modulated in a chirp sequence method or an orthogonal frequency division multiplex (OFDM) method. For example, each frame comprises a plurality of chirp signals or a plurality of OFDM symbols.

According to a preferred example embodiment of the present invention, in each case two frames differ in at least one parameter of their frequency-modulated radar signals. This makes it possible for the measurements of the individual frames to be uncorrelated and, for example, errors do not recur across cycles. The processing or evaluation according to the method takes into account the deviation of the parameters. If the modulation method is a chirp sequence method, the chirp signals of two consecutive frames preferably differ in at least one of the following parameters: the sign of the slope of the chirp signals; the sign of the change in the center frequency of the individual chirp signals in a frame; the bandwidth of the chirp signals; the amount of change in the center frequency; the ramp timing. For example, the center frequency of the chirp signals can increase or decrease within a frame. The change in the frames in at least one parameter of the signals can also be used to divide the frames between a radar system having a plurality radar sensors when said system is used, and to be able to clearly identify the sensors in the evaluation.

According to a preferred example embodiment of the present invention, in each case two frames differ in at least one parameter of their frequency-modulated radar signals, wherein the differences are designed in such a way that the total used bandwidth is increased over the measurement cycles. Thus, in addition to the improved velocity separation capability, an improved distance separation capability

$$Δ d = \frac{c}{2 BW}$$

can be obtained. Here, BW indicates the total bandwidth used and c the velocity of light.

According to a preferred example embodiment of the present invention, the frequency-modulated radar signals of a frame are arranged non-equidistantly relative to one another in time. This involves the temporal interleaving of at least two subsequences within a frame. Such interleaving makes it possible to carry out a clear determination of velocity with a correspondingly coarser resolution of the relative velocity simply by evaluating the signals of one frame. The length of the frames can also be adjusted by arranging the signals of a frame non-equidistantly, as a result of which a non-equidistant arrangement of the midpoints of a plurality of frames relative to one another is made possible.

According to a preferred example embodiment of the present invention, the joint evaluation comprises evaluating the received signals of a plurality of frames and creating a distance-Doppler velocity spectrum (range Doppler) taking into account the movement of at least one target detected by the signals.

The joint evaluation can be the evaluation of all received signals of a plurality of frames. The taking into account of the movement of at least one target detected by the signals is carried out, for example, by compensating for the change in distance (range migration). The joint evaluation makes it possible to create a very finely resolved distance-Doppler velocity spectrum, wherein ambiguities in the measured relative velocity of each target are suppressed by a transmission scheme according to the present invention. A joint evaluation requires only one joint evaluation step.

According to a preferred example embodiment of the present invention, the joint evaluation comprises a pre-processing of the received signals of individual frames and a subsequent cross-frame evaluation. Pre-processing comprises a one-dimensional frequency analysis of each received radar signal or a two-dimensional frequency analysis of each received radar signal, wherein the first dimension is the frequency per signal and the second dimension is the frequency across the signals of a frame.

Such a frequency analysis is carried out, for example, using a fast Fourier transform. The pre-processing and the cross-frame evaluation can, for example, be carried out on separate components of the radar system. Since the cross-frame evaluation requires increased computing capacity due to the number of signals to be evaluated, when carried out on a radar sensor, the sensor must comprise a corresponding configuration and the required computing power. This increases the cost of the radar sensor and can lead to heat dissipation problems, depending on the design conditions. A separation makes it possible, for example, to carry out the cross-frame evaluation on a central control unit or a central processing unit. This is particularly advantageous when the method is carried out on a MIMO (multiple input-multiple output) radar network, since a central control unit or a central processing unit can thus carry out the cross-frame evaluation of a plurality of radar sensors.

Pre-processing using one-dimensional or two-dimensional frequency analysis already makes it possible to detect the targets detected by the signals, which exhibit a sufficiently clear relative velocity or a sufficient relative velocity difference. The resolution is limited; for example, the relative velocity can be resolved to an accuracy of 0.05 m/s, so that targets with a smaller relative velocity difference can no longer be separated or a small change in the relative velocity of a target is no longer detected. The calculation results of the pre-processing can be used for the cross-frame evaluation, as a result of which the computational effort for this is reduced.

According to a preferred example embodiment of the present invention, the cross-frame evaluation comprises a one-dimensional frequency analysis of the received signals of a plurality of frames taking into account the expected phase offsets, a coherent superimposition of the results of the pre-processing and a search for at least one global maximum in the superimposed results.

The one-dimensional frequency analysis of the received signals of a plurality of frames or across the time offsets of a plurality of frames makes it possible to create a very finely resolved distance-Doppler velocity spectrum (range Doppler) taking into account the movement of at least one target detected by the signals. For example, targets can be separated which differ in their relative velocity by less than 0.05 m/s or which exhibit such a small change in their relative velocity. By using a transmission scheme according to the present invention, ambiguities in the determined relative velocity of each target that occur due to undersampling in the Doppler domain are suppressed. Likewise, a model for the phase shifts between the frames expected due to the time offsets is established for the relevant range of relative velocities. If the pre-processing only comprises a one-dimensional frequency analysis, the cross-frame evaluation can comprise a two-dimensional frequency analysis of the received signals of a plurality of frames.

According to an example embodiment of the present invention, the coherent superimposition comprises the superimposition of the results of the pre-processing, taking into account the model created and thus the expected phase shifts, with the result of the cross-cycle evaluation. For example, the results of a two-dimensional frequency analysis of the signals of the individual frames from the pre-processing are coherently superimposed with the result of a one-dimensional frequency analysis of the received signals across a plurality of frames. A global maximum or a plurality of local maxima are subsequently searched for in the superimposed result. This significantly improves the resolution of the relative velocity and enables an accurate resolution of the relative velocity spectrum.

According to a preferred example embodiment of the present invention, the frequency-modulated radar signals are modulated in a radar multiplexing method and the method is designed to operate a multiple-input-multiple-output (MIMO) radar sensor or radar network.

As a result, the advantages described of the method according to the present invention can be combined with the advantages of a MIMO radar sensor or MIMO radar network. The radar multiplexing method can, for example, be a time multiplexing scheme or a frequency multiplexing scheme; for example, the multiplexing scheme can be a time-division multiplexing (TDM) scheme, or Doppler-division multiplexing (DDM) codes can be used as the scheme.

The present invention further comprises a radar sensor with which the method according to the present invention is carried out according to any of the embodiments described above. For example, the radar sensor is designed to fully carry out the joint evaluation of a plurality of frames. The radar sensor comprises, for example, storage means that are designed to store the received signals of the plurality of frames to be evaluated together and to make them available for evaluation.

The present invention further comprises a radar network comprising at least a first and a second radar sensor, with which the method according to the present invention is carried out according to any of the embodiments described above. The radar sensors can in each case be the radar sensor described above. The radar network can further comprise a central processing unit on which at least the cross-frame evaluation is carried out. The radar sensors are designed to communicate with the central processing unit. The central processing unit can also be designed to carry out at least part of the processing of reflected signals and the complete joint evaluation of a plurality of frames.

The subject matter of the present invention is not limited to the features of the individual embodiments, but can also comprise any technically possible combination of the described embodiments of the present invention.

An exemplary embodiment is explained in more detail below with reference to the figures.

### BRIEF DESCRIPTION OF THE DRAWINGS

FIG. 1 shows a time-frequency scheme of a chirp sequence method according to the related art.

FIG. 2 shows a relative velocity spectrum with ambiguous results according to a time-frequency scheme of FIG. 1.

FIG. 3 shows a time-frequency scheme according to a first example embodiment of the present invention.

FIG. 4 shows a relative velocity spectrum with clear results according to a time-frequency scheme of the first example embodiment of the present invention.

FIG. 5 shows a time-frequency scheme according to a second example embodiment of the present invention.

FIG. 6 shows a time-frequency scheme according to a third example embodiment of the present invention.

FIG. 7 shows a time-frequency scheme according to a fourth example embodiment of the present invention.

FIG. 8 shows the steps of the method according to the present invention according to one of the first to fourth example embodiments.

### DETAILED DESCRIPTION OF EXAMPLE EMBODIMENTS

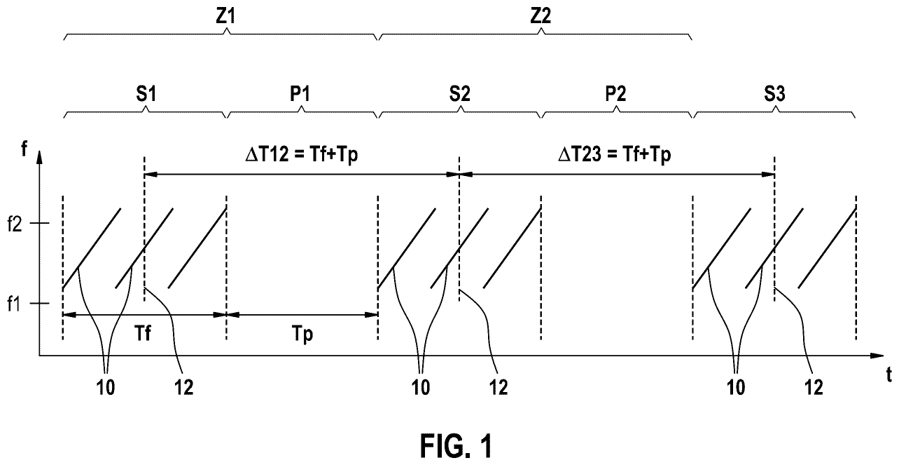

FIG. 1 shows a time-frequency scheme according to the related art. It shows the transmission of signals in a sequence of frames S1, S2, S3 (hereinafter referred to briefly as Sx), which in each case represents a sampling with three chirp radar signals 10 with increasing frequency. The chirp signals 10 are arranged in each frame Sx with the same frequency and the same frequency increase from f1 to f2 and the same distance relative to one another. Each frame Sx has the defined measurement duration Tf, wherein in each case a pause P1, P2 (hereinafter referred to briefly as Px) without chirp signals with the defined length Tp follow between the frames Sx.

According to the time-frequency scheme, in a method according to the related art, the frames Sx are in each case sampled by transmitting the signals 10 and receiving corresponding reflected signals, wherein the frames Sx are interrupted by the pauses Px. The time-frequency scheme is not limited to the number of frames, but after each frame Sx there is a pause Px; the pause after frame S3 is not shown here. Thus, the combination of a frame Sx with a subsequent pause Px forms a measurement cycle 21, 22 (hereinafter referred briefly to as Zx), as a result of which the scheme comprises a plurality of identical measurement cycles Z1, Z2. In this case, ΔT=Tf+Tp. For example, Tf is 20 ms and Tp is 20 ms, so that ΔT=40 ms. Here, ΔT describes the distance from the midpoint 12 of one frame Sx to the midpoint 12 of another frame Sx. Due to the identical length Tf of the frames Sx and the identical lengths Tp of the pauses Px, the midpoints 12 of the frames Sx are arranged equidistantly relative to one another.

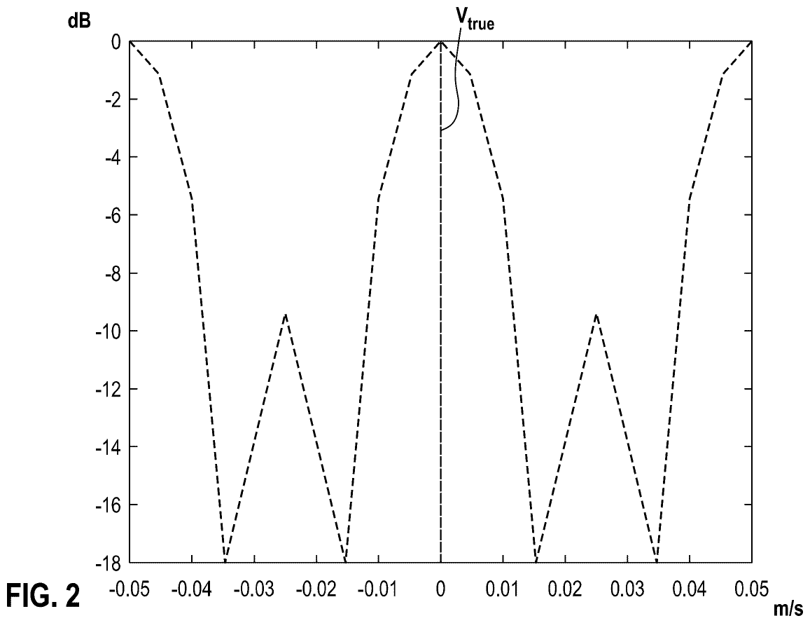

By jointly evaluating a plurality of frames Sx or measurement cycles Zx to increase the effective measurement duration and the resulting improved resolution, ambiguous results in relation to velocity hypotheses are obtained, as shown in FIG. 2.

FIG. 2 shows a relative velocity spectrum with ambiguous results after the joint evaluation of a plurality of frames according to a time-frequency scheme of FIG. 1. Here, the sampled frames are evaluated and displayed across frames, or in other words, the measurement cycles are evaluated and displayed across cycles. The true relative velocity of a measured example target vₜᵣᵤₑ is 0 m/s. Due to the pauses Px between the frames Sx, ambiguous results occur due to undersampling in the Doppler domain. This means that there are a plurality of velocity hypotheses with the same power level in the range of 0 dB, at −0.05 m/s, 0 m/s and 0.05 m/s. Thus, a clear determination of the real relative velocity of the target is no longer possible.

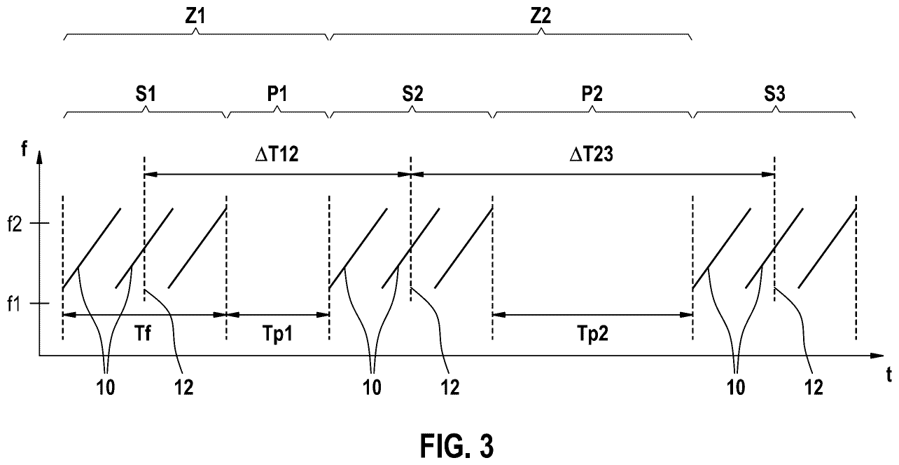

FIG. 3 shows a time-frequency scheme (hereinafter referred to briefly as scheme) according to a first embodiment of the present invention. The scheme comprises transmitting signals in a plurality of frames S1, S2, S3 (hereinafter referred to briefly as Sx), which in each case comprise three chirp radar signals 10 with increasing frequency. The chirp signals 10 are arranged in each frame Sx with the same frequency and the same frequency increase from f1 to f2 and the same distance relative to one another. Each frame Sx has the defined measurement duration Tf, wherein, between the frames, in each case a pause P1, P2 (hereinafter referred to briefly as Px) follows without chirp signals 10. Here, the defined lengths Tp1, Tp2 of the pauses P1, P2 are different, where Tp1≠Tp2. This results in different ΔT values: ΔT12 and ΔT23. Here, ΔT12 indicates the distance between the midpoints 12 of frames S1 and S2, and ΔT23 indicates the distance between the midpoints 12 of frames S2 and S3. Due to the different lengths of the pauses Px, ΔT12 #ΔT23. This means that the midpoints 12 of the frames Sx are arranged non-equidistantly relative to one another.

In the first embodiment shown, the duration of the pauses Px is selected in such a way that the midpoints 12 of in each case two of the successive frames Sx exhibit different time offsets ΔT. The embodiment also comprises further frames Sx not shown here, wherein the pauses Px are selected in such a way that the specified condition is met in each case between two adjacent frames Sx; that is to say that the midpoints 12 of the frames Sx exhibit a non-equidistant arrangement relative to one another. The embodiment also comprises, for example, pauses Px that are selected in such a way that no pause Px is equal to another pause Px; i.e., no two distances between the midpoints 12 of the frames Sx are equal. This makes an evaluation possible across a large number of frames Sx or measurement cycles Zx without a cross-frame or cross-cycle evaluation producing ambiguous results.

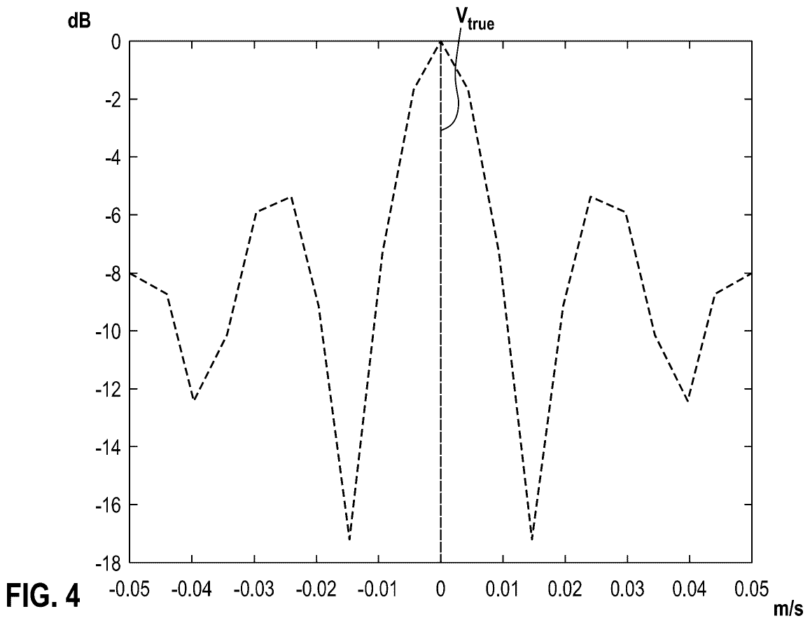

FIG. 4 shows a relative velocity spectrum with clear results after the joint evaluation of the received signals of a plurality of frames that were transmitted according to a time-frequency scheme of the embodiment shown in FIG. 3. Here, the sampled frames are evaluated and displayed across frames, or in other words, the measurement cycles are evaluated and displayed across cycles. The true relative velocity of a measured example target vₜᵣᵤₑ is 0=m/s. Due to the different lengths Tp1, Tp2 of the pauses Px between the frames Sx and the resulting non-equidistant arrangement of the midpoints 12, the ambiguities caused by undersampling in the Doppler domain can be suppressed. Therefore, only one velocity hypothesis exists in the range of a power level of 0 dB, and the velocity hypotheses shown in FIG. 2 that do not correspond to vₜᵣᵤₑ are significantly below the power level of vₜᵣᵤₑ, here for example in the range of −8 dB. As a result, a clear determination of the relative velocity with a simultaneous fine resolution of the relative velocity in the range of less than 0.05 m/s is possible.

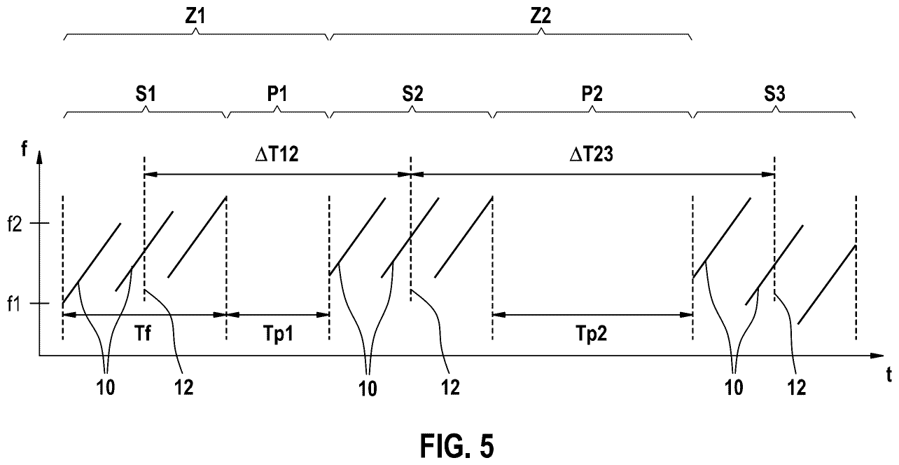

FIG. 5 shows a time-frequency scheme (hereinafter referred to briefly as scheme) according to a second embodiment of the present invention. The scheme comprises transmitting signals in a plurality of frames S1, S2, S3 (hereinafter referred to briefly as Sx), which in each case comprise three chirp radar signals 10 with increasing frequency. The chirp signals 10 are arranged in each frame Sx with the same frequency increase from f1 to f2 and the same distance relative to one another. The transmission signals 10 of the frames Sx vary relative to one another in at least one parameter. In the present embodiment, the frame S1 comprises an increasing center frequency of the chirp signals 10 within the frame. The frame S2 comprises a constant center frequency of the chirp signals 10 within the frame. And the frame S3 comprises a decreasing center frequency of the chirp signals 10 within the frame. Each frame Sx has the identical defined measurement duration Tf. The pauses Px correspond in their design to the pauses of the scheme shown in FIG. 3; the features described there therefore also apply here and are not repeated. Due to the carrying out of the pauses Px, the midpoints 12 of the frames Sx exhibit a non-equidistant arrangement relative to one another. Therefore, the corresponding advantages of the clear determination of velocity described in FIG. 3 can also be realized here.

By changing at least one parameter of the frames Sx relative to one another-here, as described, different changes in the center frequency via the chirp signals 10—the measurements of the individual measurement cycles Zx are uncorrelated. This makes it possible to distinguish the reflected signals of the frames Sx, wherein the joint evaluation of a plurality of frames Sx naturally takes into account the differences in the parameters. When the method is implemented with a plurality of radar sensors and the time-frequency scheme is divided between the radar sensors, a distinction can be made between the sensors that have transmitted the corresponding signals. The embodiment is not limited to the variation of the change in the center frequency shown, but also comprises any other change in the parameters of the frames relative to one another. Such a change can be, for example, a change in the sign of the slope of the chirp signals; the sign of the change in the center frequency of the individual chirp signals in a frame; the bandwidth of the chirp signals; the amount of change in the center frequency; the ramp timing. The changes can be combined as desired so that the chirp signals 10 of two consecutive frames Sx differ in at least one of the parameters and/or so that all frames Sx of the scheme of the embodiment differ in at least one parameter from all other frames Sx. These changes can also be used to increase the total used bandwidth (BW) across the measurement cycles, so that, in addition to the improved velocity separation c capability, an improved distance separation capability Δd=c/2BW can also be achieved.

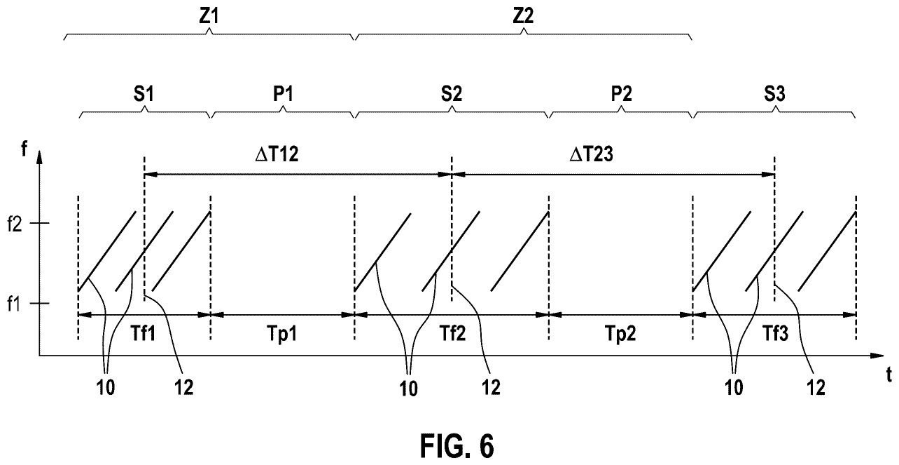

FIG. 6 shows a time-frequency scheme (hereinafter referred to briefly as scheme) according to a third embodiment of the present invention. The scheme comprises transmitting signals in a plurality of frames S1, S2, S3 (hereinafter referred to briefly as Sx), which in each case comprise three chirp radar signals 10 with increasing frequency. The chirp signals 10 have the same frequency increase from f1 to f2 in each frame Sx and are arranged at the same distance relative to one another. The distances of the chirp signals 10 between the frames Sx vary. Thus, the frames S1, S2, S3 exhibit different defined lengths Tf1, Tf2, Tf3, where Tf1≠Tf2≠Tf3. Here, the lengths Tp of the pauses P1, P2 (hereinafter referred to briefly as Px) are identical, where Tp1=Tp2.

Due to the different lengths of the frames Sx, different ΔT values result: ΔT12 and ΔT23, wherein ΔT12≠ΔT23. Here, ΔT12 indicates the distance between the midpoints 12 of frames S1 and S2, and ΔT23 indicates the distance between the midpoints 12 of frames S2 and S3. Therefore, the midpoints 12 of the frames Sx are arranged non-equidistantly relative to one another and the corresponding advantages of the clear determination of velocity described in FIG. 3 can also be realized here.

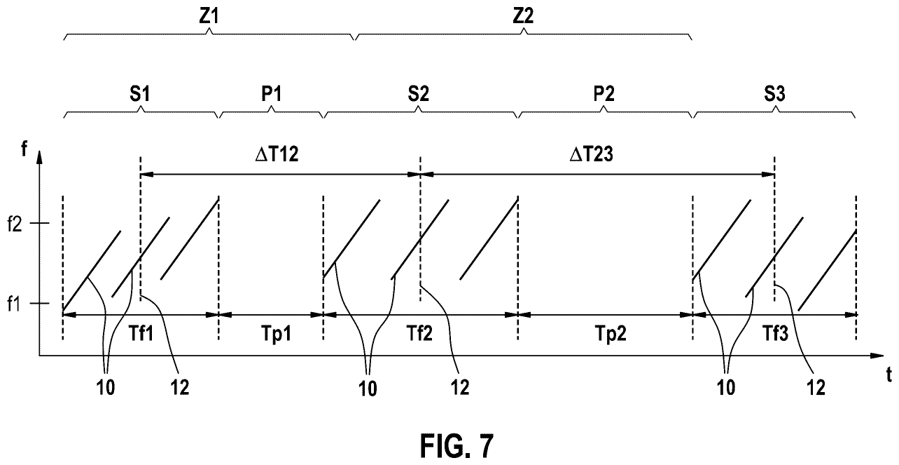

FIG. 7 shows a time-frequency scheme (hereinafter referred to briefly as scheme) according to a fourth embodiment of the present invention. This embodiment represents a combination of the embodiments shown in FIGS. 3, 5 and 6. The scheme comprises transmitting signals in a plurality of frames S1, S2, S3 (hereinafter referred to briefly as Sx), which in each case comprise three chirp radar signals 10 with increasing frequency. The chirp signals 10 are arranged in each frame Sx with the same frequency increase from f1 to f2 and identical distance within the frame relative to one another. The frames Sx vary in at least one parameter relative to one another as described in FIG. 5. Likewise, the distances of the chirp signals 10 between the frames Sx vary as described in FIG. 6. Thus, the frames S1, S2, S3 exhibit different defined lengths Tf1, Tf2, Tf3, where Tf1 #Tf2 #Tf3. Likewise, the defined lengths Tp of the pauses P1, P2 (hereinafter referred to briefly as Px) are different, as described in FIG. 3, where Tp1≠Tp2.

The combination of the different lengths Tf1, Tf2, Tf3 of the frames S1, S2, S3 with the different lengths Tp1, Tp2 of the pauses P1, P2 also results in different ΔT values: ΔT12 and ΔT23. Here, ΔT12 indicates the distance between the midpoints 12 of frames S1 and S2, and ΔT23 indicates the distance between the midpoints 12 of frames S2 and S3. Therefore, the midpoints 12 of the frames S1, S2 and S3 are arranged non-equidistantly relative to one another and the corresponding advantages of the clear determination of velocity described in FIG. 3 can also be realized here. By changing at least one parameter of the frames relative to one another-here, as described, the different change in the center frequency across the chirp signals 10 of a frame Sx—the measurements of the individual measurement cycles Zx are uncorrelated and comprise the advantages described in FIG. 5.

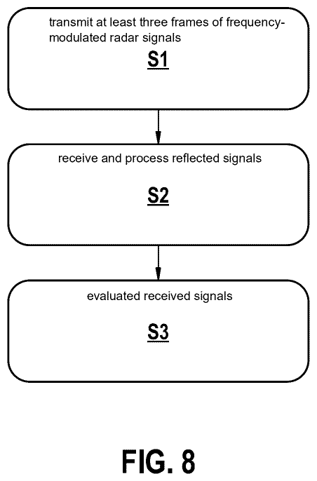

FIG. 8 shows the steps of the method according to the present invention according to one of the first to fourth embodiments. In this case, step S1 comprises transmitting at least three frames of frequency-modulated radar signals according to a time-frequency scheme of one of the described embodiments. The frames in each case exhibit a defined duration and are separated in each case by a pause of a defined length. The midpoints of the frames are arranged non-equidistantly relative to one another due to the selection of a corresponding time-frequency scheme.

In step S2, reflected signals are received and processed. This is done in the usual way depending on the radar system used. For example, the signals are demodulated analogously and subsequently provided for evaluation by an analog-to-digital converter.

In step S3, the received signals are evaluated, wherein the evaluation can comprise a joint evaluation of the received signals of a plurality of frames and creation of a distance-Doppler velocity spectrum. The evaluation can comprise a prior pre-processing of the received signals of individual frames and a subsequent cross-frame evaluation according to the embodiments described above.

The embodiments described and those shown in the figures can of course be combined with one another in any way, to the extent that this is technically possible. This comprises in particular the combination of the variation of the lengths Tf and Tp along with the change of the frames relative to one another in at least one parameter. Therefore, the present invention is not limited to the embodiments shown, but comprises any combination of embodiments falling within the scope of the present invention.

What is claimed is:

1. A method for operating a radar sensor or radar network, comprising the following steps:
transmitting at least three frames of frequency-modulated radar signals, with a defined duration of each frame and a plurality of frequency-modulated radar signals per frame, wherein the transmitting includes a defined pause between in each two frames, wherein the duration of the frames and/or the duration of the pauses are selected in such a way that midpoints of the frames exhibit a non-equidistant arrangement relative to one another;
receiving and processing reflected signals;
jointly evaluating a plurality of frames.

2. The method according to claim 1, wherein the frequency-modulated radar signals are modulated in a chirp sequence method or an orthogonal frequency division multiplex method.

3. The method according to claim 1, wherein each two frames differ in at least one parameter of their frequency-modulated radar signals.

4. The method according to claim 1, wherein the frequency-modulated radar signals of each frame are arranged non-equidistantly relative to one another in time.

5. The method according to claim 1, wherein the joint evaluation includes evaluating the received signals of the plurality of frames and creating a distance-Doppler velocity spectrum taking into account a movement of at least one target detected by the signals.

6. The method according to claim 1, wherein:
the joint evaluation includes a pre-processing of the received signals of individual frames and a subsequent cross-frame evaluation;
the pre-processing includes a one-dimensional frequency analysis of each received radar signal or a two-dimensional frequency analysis, wherein a first dimension includes a frequency per signal and the second dimension includes the frequency across the signals of a frame.

7. The method according to claim 6, wherein the cross-frame evaluation includes a one-dimensional frequency analysis of the received signals of the plurality of frames taking into account expected phase offsets, a coherent superimposition of the results of the pre-processing and a search for at least one local or global maximum in superimposed results.

8. The method according to claim 1, wherein the frequency-modulated radar signals are modulated in a radar multiplexing method and wherein the method is configured to operate a multiple-input-multiple-output (MIMO) radar sensor or radar network.

9. A radar sensor, configured to:
transmit at least three frames of frequency-modulated radar signals, with a defined duration of each frame and a plurality of frequency-modulated radar signals per frame, wherein the transmitting includes a defined pause between in each two frames, wherein the duration of the frames and/or the duration of the pauses are selected in such a way that midpoints of the frames exhibit a non-equidistant arrangement relative to one another;
receive and process reflected signals;
jointly evaluate a plurality of frames.

10. A radar network comprising at least a first and a second radar sensor, the radar network configured to:
transmit at least three frames of frequency-modulated radar signals, with a defined duration of each frame and a plurality of frequency-modulated radar signals per frame, wherein the transmitting includes a defined pause between in each two frames, wherein the duration of the frames and/or the duration of the pauses are selected in such a way that midpoints of the frames exhibit a non-equidistant arrangement relative to one another;
receive and process reflected signals;
jointly evaluate a plurality of frames;
wherein the frequency-modulated radar signals are modulated in a radar multiplexing method.
